(19) United States
(12) Patent Application Publication
(10) Pub. No.: US 2025/0148953 A1
(43) Pub. Date: May 8, 2025

(54) Electronic device

(71) Applicant: InnoLux Corporation, Miao-Li County (TW)

(72) Inventors: Cheng-Min WU, Miao-Li County (TW); Sheng-Feng HUANG, Miao-Li County (TW)

(21) Appl. No.: 18/910,616

(22) Filed: Oct. 9, 2024

(30) Foreign Application Priority Data
Nov. 8, 2023 (CN) 202311480344.2

(51) Int. Cl. G09G 3/20

(52) U.S. Cl. CPC G09G 3/2007; G09G 2300/0842; G09G 2310/08

(57) ABSTRACT

An electronic device includes a substrate, at least a data line disposed on the substrate for transmitting data, and at least a pixel circuit disposed on the substrate. The pixel circuit includes a memory element, a capacitor, a first switch element, a second switch element, and a third switch element. The capacitor is electrically connected to the memory element. One end of the first switch element is electrically connected to the data line. The second switch element is electrically connected between the first switch element and the memory element. The third switch element is electrically connected between the first switch element and the capacitor. When the second switch element is turned on, the data is transmitted to the memory element. When the third switch element is turned on, the data is transmitted to one end of the capacitor.

### CROSS-REFERENCE TO RELATED APPLICATIONS

This application claims the benefits of the Chinese Patent Application Ser. No. 202311480344.2, filed on Nov. 8, 2023, the subject matter of which is incorporated herein by reference.

### BACKGROUND

### Field of the Disclosure

The present disclosure relates to an electronic device and, more particularly, to an electronic device capable of being switched between normal display and MIP display.

### Description of Related Art

In order to save power consumption, in the existing technology, an MIP (Memory In Pixel) display design has been proposed, but it can only be used to display black and white images. If it is desired to achieve the effect of displaying different gray-scales, multiple sets of MIP circuits have to be designed in one pixel. For example, two sets of MIP circuits may be used to achieve a 2-bit (4-gray-scale) display, and three sets of MIP circuits may be used to achieve a 3-bit (8-gray-scale) display. However, due to the limited pixel space, it is actually difficult to design multiple sets of MIP circuits to display a multi-gray-scale display (such as 64-gray-scale, 256-gray-scale, and so on).

Therefore, it is desired to provide an improved electronic device to alleviate and/or obviate the aforementioned problems.

### SUMMARY

The present disclosure provides an electronic device, which includes: a substrate; at least a data line disposed on the substrate for transmitting data; and at least a pixel circuit disposed on the substrate, including: a memory element; a capacitor electrically connected to the memory element; a first switch element, wherein a connection end of the first switch element is electrically connected to the data line; a second switch element electrically connected between the first switch element and the memory element; and a third switch element electrically connected between the first switch element and the capacitor, wherein the data is transmitted to the memory element when the second switch element is turned on, and the data is transmitted to one end of the capacitor when the third switch element is turned on.

The present disclosure further provides an electronic device, which includes: a substrate; at least a data line disposed on the substrate for transmitting data; and at least a pixel circuit disposed on the substrate, including: a memory element; a first switch element, wherein a connection end of the first switch element is electrically connected to the data line; a sixth switch element, wherein the sixth switch element and the memory element are connected to a node; a capacitor having a first end electrically connected to the sixth switch element, and a second end electrically connected to a common voltage; and a seventh switch element electrically connected between the data line and the sixth switch element, wherein the data is transmitted to the memory element when the sixth switch element is turned on, and the data is transmitted to the first end of the capacitor when the seventh switch element is turned on.

Other novel features of the disclosure will become more apparent from the following detailed description when taken in conjunction with the accompanying drawings.

### BRIEF DESCRIPTION OF DRAWINGS

FIG. 1 shows a schematic diagram of an electronic device of the present disclosure;

FIG. 2A shows a schematic circuit diagram of a pixel circuit according to an embodiment of the present disclosure;

FIG. 2B shows a detailed circuit diagram of the pixel circuit of FIG. 2A;

FIG. 2C shows the driving timing of the pixel circuit of FIG. 2A in the MIP display mode;

FIG. 2D shows the driving timing of the pixel circuit of FIG. 2A in the normal display mode;

FIG. 3A shows a schematic circuit diagram of a pixel circuit according to another embodiment of the present disclosure;

FIG. 3B shows a detailed circuit diagram of the pixel circuit of FIG. 3A;

FIG. 3C shows the driving timing of the pixel circuit of FIG. 3A in the MIP display mode;

FIG. 3D shows the driving timing of the pixel circuit of FIG. 3A in the normal display mode;

FIG. 4A shows a schematic circuit diagram of a pixel circuit according to still another embodiment of the present disclosure;

FIG. 4B shows a detailed circuit diagram of the pixel circuit of FIG. 4A;

FIG. 4C shows the driving timing of the pixel circuit of FIG. 4A in the MIP display mode; and

FIG. 4D shows the driving timing of the pixel circuit of FIG. 4A in the normal display mode.

### DETAILED DESCRIPTION OF EMBODIMENT

Different embodiments of the present disclosure are provided in the following description. These embodiments are meant to explain the technical content of the present disclosure, but not meant to limit the scope of the present disclosure. A feature described in an embodiment may be applied to other embodiments by suitable modification, substitution, combination, or separation.

It should be noted that, in the present specification, when a component is described to “comprise”, “have”, “include” an element, it means that the component may include one or more of the elements, and the component may include other elements at the same time, and it does not mean that the component has only one of the element, except otherwise specified.

Moreover, in the present specification, the ordinal numbers, such as “first” or “second”, are only used to distinguish a plurality of elements having the same name, and it does not means that there is essentially a level, a rank, an executing order, or an manufacturing order among the elements, except otherwise specified. The ordinal numbers of the elements in the specification may not be the same in claims. For example, a “second” element in the specification may be a “first” element in the claims.

In the present specification, except otherwise specified, the feature A “or” or “and/or” the feature B means only the existence of the feature A, only the existence of the feature B, or the existence of both the features A and B. The feature A “and” the feature B means the existence of both the features A and B.

Moreover, in the present specification, the terms, such as “top”, “upper”, “bottom”, “front”, “back”, or “middle”, as well as the terms, such as “on”, “above”, “over”, “under”, “below”, or “between”, are used to describe the relative positions among a plurality of elements, and the described relative positions may be interpreted to include their translation, rotation, or reflection.

Furthermore, the terms recited in the specification and the claims such as “above”, “over”, “on”, “below”, or “under” are intended that an element may not only directly contacts other element, but also indirectly contact the other element.

Furthermore, the term recited in the specification and the claims such as “connect” is intended that an element may not only directly connect to other element, but also indirectly connect to other element. On the other hand, the terms recited in the specification and the claims such as “electrically connect” and “couple” are intended that an element may not only directly electrically connect to other element, but also indirectly electrically connect to other element.

In the present specification, except otherwise specified, the terms (including technical and scientific terms) used herein have the meanings generally known by a person skilled in the art. It should be noted that, except otherwise specified in the embodiments of the present disclosure, these terms (for example, the terms defined in the generally used dictionary) should have the meanings identical to those skilled in the art, the background of the present disclosure or the context of the present specification, and should not be read by an ideal or over-formal way.

In addition, the electronic device disclosed in the present disclosure may include a display device, a tiled device, a touch display device, a curved display device, or a free shape display device, but not limited thereto. The electronic device may be a bendable or flexible electronic device. The electronic device may include liquid crystals, light emitting diodes, fluorescence, phosphor, other suitable display media, or a combination thereof, but not limited thereto. The display device may be a non-self-luminous display device or a self-luminous display device. The electronic components may include passive and active components, such as capacitors, resistors, inductors, diodes, transistors, etc. The diodes may include light emitting diodes (LEDs) or photodiodes. The light emitting diodes may include, for example, organic light emitting diodes (OLEDs), mini light emitting diodes (mini LEDs), micro light emitting diodes (micro LEDs), or quantum dot light emitting diodes (quantum do LEDs), but not limited thereto. The tiled device may be, for example, a display tiled device or an antenna tiled device, but not limited thereto. It is noted that, the electronic device may be any arrangement and combination of the foregoing, but not limited thereto. In addition, the electronic device may be a bendable or flexible electronic device. It is noted that, the electronic device may be any arrangement and combination of the foregoing, but not limited thereto. In addition, the appearance of the electronic device may be rectangular, circular, polygonal, a shape with curved edges, or other suitable shapes. The electronic device may be provided with a peripheral system such as a driving system, a control system, a light source system, a shelf system, etc. to support a display device, an antenna device or a tiled device. For the convenience of description, a display device will be used as the electronic device for description in the following, but the present disclosure is not limited thereto.

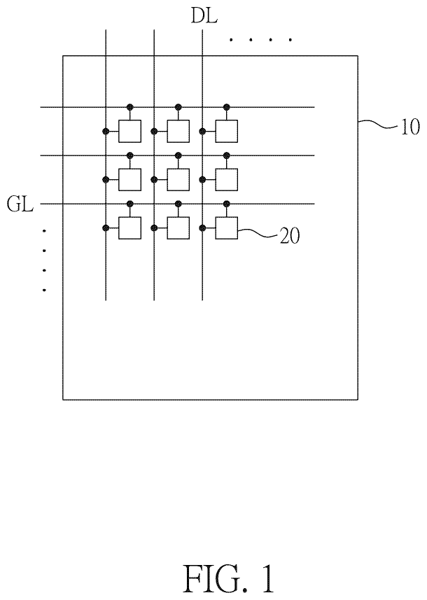

FIG. 1 shows a schematic diagram of an electronic device of the present disclosure. The electronic device of the present disclosure includes a substrate 10, and at least a pixel circuit 20, at least a scan line GL and at least a data line DL disposed on the substrate 10. In one embodiment, the pixel circuits 10 are arranged, for example but not limited thereto, in a matrix form. In addition, the data lines DL are disposed on the substrate 10 to transmit the data to be displayed. The scan lines GL are disposed on the substrate 10 to provide scanning signals for driving the pixel circuits 20. The scan lines GL and the data lines DL are disposed to be intersected with each other, thereby enabling the pixel circuits 20 to provide a picture display function under the driving of the scan lines GL and the data lines DL.

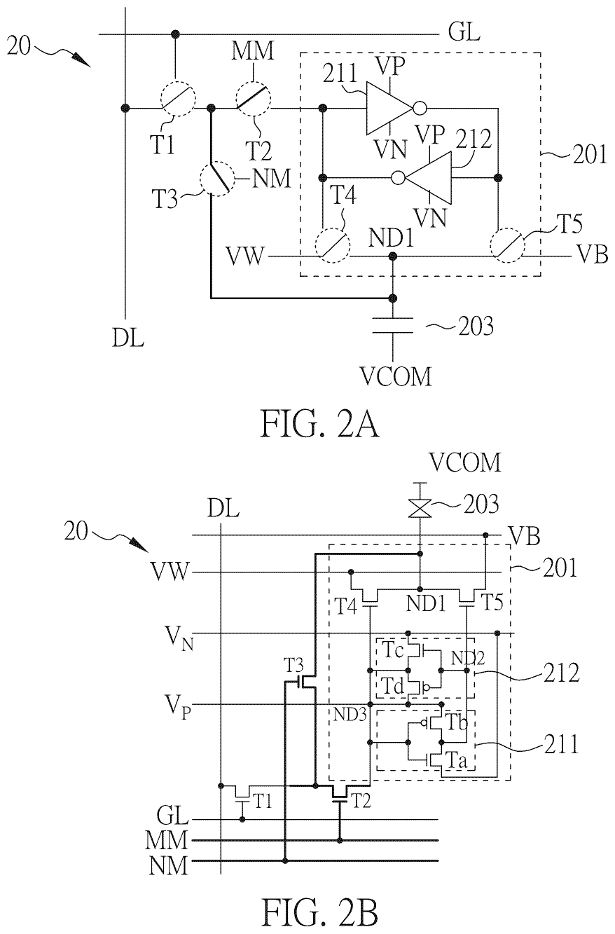

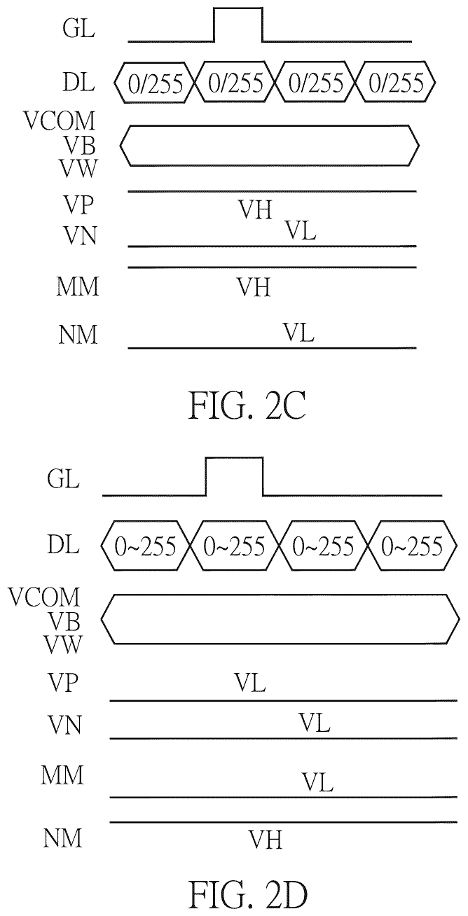

Please refer to FIG. 1 to FIG. 2B at the same time. FIG. 2A shows a schematic circuit diagram of the pixel circuit 20 according to an embodiment of the present disclosure, and FIG. 2B shows a detailed circuit diagram of the pixel circuit 20 of FIG. 2A, wherein the pixel circuit 20 includes a memory element 201, a capacitor 203, a first switch element T1, a second switch element T2, and a third switch element T3. In one embodiment, the memory element 201 includes a first inverter 211, a second inverter 212, a fourth switch element T4 and a fifth switch element T5, wherein, through the output end of the first inverter 211 being connected to the input end of the second inverter 212 and the output end of the second inverter 212 being connected to the input end of the first inverter 211, the memory element 201 may be provided with a memory function of data latch. More specifically, in In one embodiment, the first inverter 211 and the second inverter 212 may include metal-oxide-semiconductor field-effect transistor (MOSFET), thin film transistor or other suitable electronic components. For example, the first inverter 211 may include a first transistor Ta and a second transistor Tb, and the second inverter 212 may include a third transistor Tc and a fourth transistor Td, wherein the first transistor Ta and the third transistor Tc may be, for example, N-type metal-oxide-semiconductor field-effect transistors (NMOS), and the second transistor Tb and the fourth transistor Td may be, for example, P-type metal-oxide-semiconductor field-effect transistors (PMOS), and wherein the first end of the first transistor Ta may be connected to a voltage supply end VN, the second end of the first transistor Ta, the first end of the second transistor Tb, the control end of the third transistor Tc, the control end of the fourth transistor Td and the control end of the fifth switch element T5 may be connected to a node ND2, the second end of the second transistor Tb may be connected to the first end of the fourth transistor Td (that is, the two PMOS may be connected to each other), the second end of the fourth transistor Td, the first end of the third transistor Tc, the control end of the first transistor Ta, the control end of the second transistor Tb, the control end of the fourth transistor T4 and the second switch element T2 may be connected to another node ND3, and the second end of the third transistor Tc may be connected to the voltage supply end VN, so that the first inverter 211 and the second inverter 212 may realize the memory function of data latch. However, it is noted that the circuit structure of the memory element 201 described here is only an example, and the circuit structure of the memory element 201 of the present disclosure that provides the memory function is not limited to this example. Furthermore, the fourth switch element T4 and the fifth switch element T5 are connected to the node ND1. The fourth switch element T4 has two connection ends respectively connected to the first signal VW and the node ND1, and a control end connected to the output end of the second inverter 212 (or the input end of the first inverter 211). The fifth switch element T5 has two connection ends respectively connected to the second signal VB and the node ND1, and a control end connected to the output end of the first inverter 211 (or the input end of the second inverter 212). Therefore, according to the data latched by the first inverter 211 and the second inverter 212, the fourth switch element T4 may be turned on and the fifth switch element T5 may be turned off so as to connect the first signal VW to the node ND1, or the fifth switch element T5 may be turned on and the fourth switch element T4 may be turned off so as to connect the second signal VB to the node ND1. That is, by controlling the fourth switch element T4 in the memory element 201, the first signal VW is transmitted to the node ND1 or, by controlling the fifth switch element T5 in the memory element 201, the second signal VB is transmitted to the node ND1. In one embodiment, the first signal VW may be, for example, a white signal (for example, a signal representing a gray-scale value of 255, but it is not limited thereto), and the second signal VB may be a black signal (for example, a signal representing a gray-scale value of 0, but it is not limited thereto), while this is only an example, and the present disclosure is not limited thereto.

Please still refer to FIG. 2A and FIG. 2B. The capacitor 203 is electrically connected to the memory element 201. Specifically, one end of the capacitor 203 is connected to the node ND1 of the memory element 201, and another end thereof is connected to the common voltage VCOM. The capacitor 203 is, for example, a liquid crystal capacitor, while this is only an example but not a limitation. In some embodiments, the liquid crystals (not shown) in the panel are sandwiched between the pixel electrodes and the common voltage electrode. In this case, the capacitor 203 may be formed by the pixel electrode and the common voltage electrode, while it is not limited thereto. In addition, one connection end of the first switch element T1 is electrically connected to the data line DL, another connection end thereof is electrically connected to the memory element 201, and a control end thereof is connected to the scan line GL, so that the first switch element T1 is controlled by the scan line GL to be turned on or off. The second switch element T2 is electrically connected between the first switch element T1 and the memory element 201; that is, the two connection ends of the second switch element T2 are respectively electrically connected to another connection end of the first switch element T1 and the output end of the second inverter 212 (or the input end of the first inverter 211) of the memory element 201, and the second switch element T2 may be controlled by the control signal MM to be turned on or off. The third switch element T3 is electrically connected between the first switch element T1 and the capacitor 203; that is, the two connection ends of the third switch element T3 are respectively electrically connected to another connection end of the first switch element T1 and one end of the capacitor 203, and the third switch element T3 may be controlled by the control signal NM to be turned on or off. In one embodiment, the source of the control signal NM or the control signal MM may come from a system end or a chip end (not shown) connected to the pixel circuit 20, while it is not limited thereto.

With the pixel circuit 20 described in FIG. 2A and FIG. 2B, the electronic device may be switched to a normal display mode or a MIP display mode. Please refer to FIG. 2C and FIG. 2D, wherein FIG. 2C shows the driving timing of the pixel circuit of FIG. 2A in the MIP display mode, and FIG. 2D shows the driving timing of the pixel circuit of FIG. 2A in the normal display mode. As shown in FIG. 2C, in the MIP display mode, the control signal MM is a first voltage level VH (for example, but not limited to, a high voltage level) and the control signal NM is a second voltage level VL (for example, but not limited to, a low voltage level), so that the second switch element T2 is turned on and the third switch element T3 is turned off, thereby transmitting data to the memory element 201 for being further written into the capacitor 203. Therefore, the pixel circuit 20 is driven in the MIP display mode, and its detailed driving timing is shown in FIG. 2C. As shown in FIG. 2D, in the normal display mode, the control signal MM is the second voltage level VL and the control signal NM is the first voltage level VH, so that the second switch element T2 is turned off and the third switch element T3 is turned on, thereby transmitting data to one end of the capacitor 203 for being further written into the capacitor 203. Therefore, the pixel circuit 20 is driven in the normal display mode, and its detailed driving timing is shown in FIG. 2D. In one embodiment, in the normal display mode, in order to reduce the voltage level of the memory element 201 that affects the capacitor 203, both the voltage supply ends VP of the first inverter 211 and the second inverter 212 may be set to a low voltage level (VL) to disable the first inverter 211 and the second inverter 212, but it is not limited thereto.

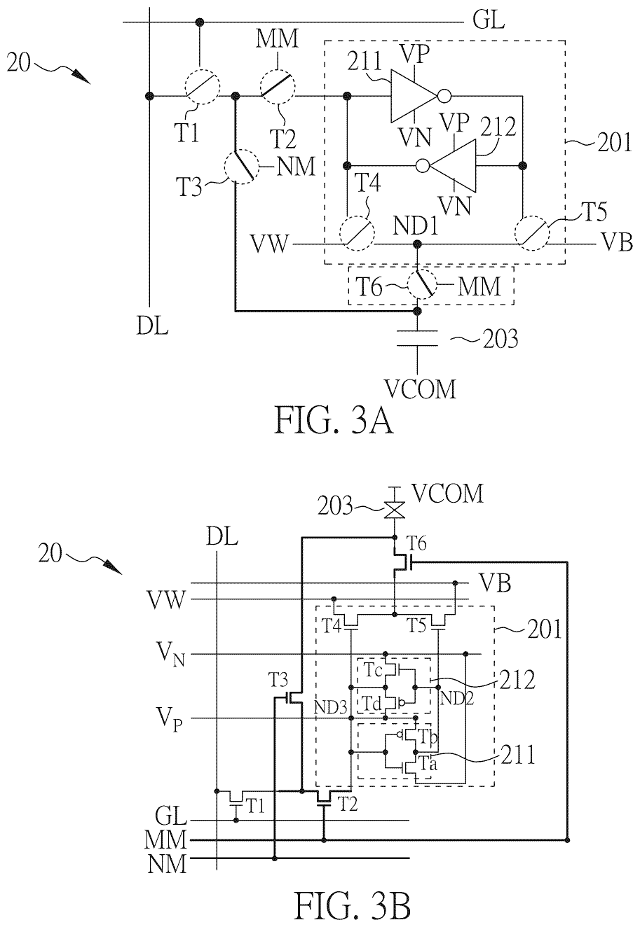

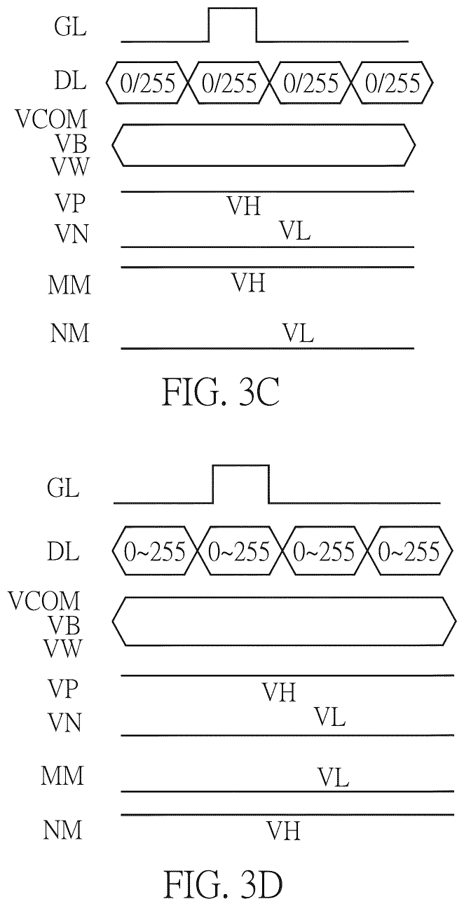

The pixel circuit 20 of the present disclosure may have different implementation aspects. FIG. 3A shows a schematic circuit diagram of the pixel circuit 20 according to another embodiment of the present disclosure, FIG. 3B shows a detailed circuit diagram of the pixel circuit 20 of FIG. 3A, and please refer to FIG. 3A and FIG. 3B together. The pixel circuit 20 of this embodiment is similar to the embodiment of FIG. 2A and FIG. 2B, except that it further includes a sixth switch element T6. The sixth switch element T6 is electrically connected between the node ND1 and the third switch element T3, or electrically connected between the node ND1 and the capacitor 203, and the sixth switch element T6 may be controlled by the control signal MM to be turned on or off. The description of the embodiment of FIG. 2A and FIG. 2B may be applicable to the pixel circuit 20 of this embodiment, and thus the following description of the pixel circuit 20 of FIG. 3A and FIG. 3B will focus on the differences.

With the pixel circuit 20 described in FIG. 3A and FIG. 3B, the electronic device may be switched to a normal display mode or a MIP display mode. Please refer to FIG. 3C and FIG. 3D, wherein FIG. 3C shows the driving timing of the pixel circuit of FIG. 3A in the MIP display mode, and FIG. 3D shows the driving timing of the pixel circuit of FIG. 3A in the normal display mode. As shown in FIG. 3C, in the MIP display mode, the control signal MM is a first voltage level VH (for example, but not limited to, a high voltage level) and the control signal NM is a second voltage level VL (for example, but not limited to, a low voltage level), so that the second switch element T2 is turned on, the third switch element T3 is turned off and the sixth switch element T6 is turned on, thereby transmitting data to the memory element 201 for being further written into the capacitor 203. Therefore, the pixel circuit 20 is driven in the MIP display mode, and its detailed driving timing is shown in FIG. 3C. As shown in FIG. 3D, in the normal display mode, the control signal MM is the second voltage level VL and the control signal NM is the first voltage level VH, so that the second switch element T2 is turned off, the third switch element T3 is turned on and the sixth switch element T6 is turned off, thereby transmitting data to one end of the capacitor 203 for being written into the capacitor 203. Therefore, the pixel circuit 20 is driven in the normal display mode, and its detailed driving timing is shown in FIG. 3D. In one embodiment, in the normal display mode, the sixth switch element T6 disposed between the node ND1 and the third switch element T3 is turned off, and thus the volatge level on the first inverter 211 and the second inverter 212 of the memory element 201 that affects the capacitor 203 may be reduced.

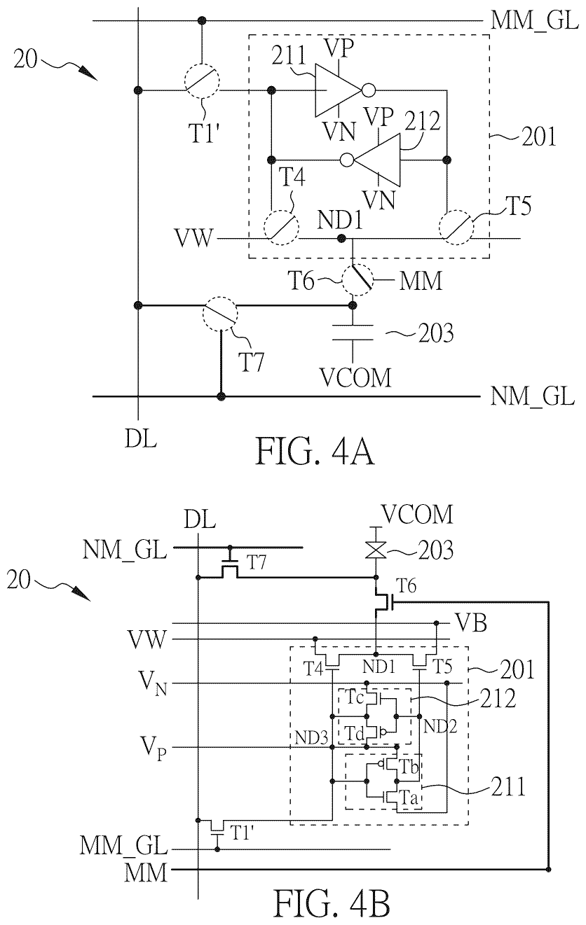

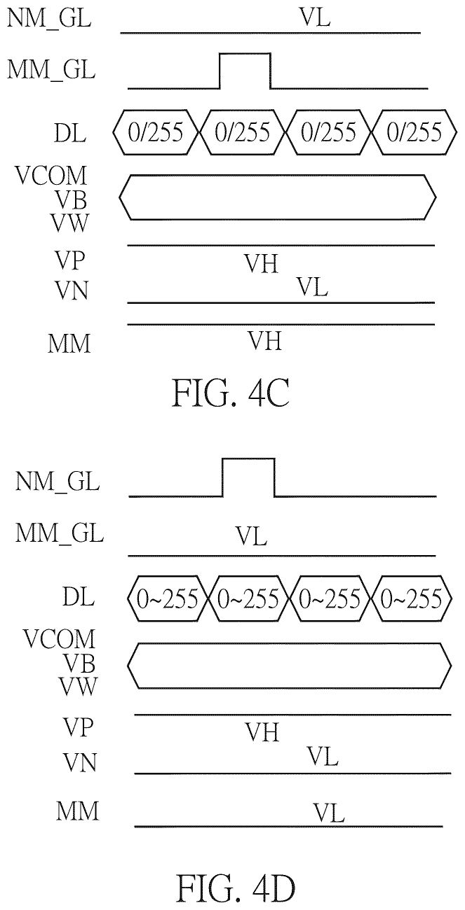

The pixel circuit 20 of the present disclosure may have different implementation aspects. FIG. 4A shows a schematic circuit diagram of the pixel circuit 20 according to another embodiment of the present disclosure, FIG. 4B shows a detailed circuit diagram of the pixel circuit 20 of FIG. 4A, and please refer to FIG. 4A and FIG. 4B together. The pixel circuit 20 includes a memory element. 201, a capacitor 203, a first switch element T1′, a sixth switch element T6, and a seventh switch element T7. The structure of the memory element 201 is the same as that of the embodiment of FIG. 2, and thus a detailed description is deemed unnecessary. In addition, in this embodiment, the scan line GL may include a first scan line MM_GL and a second scan line NM_GL.

One end of the capacitor 203 is electrically connected to the sixth switch element T6 or the seventh switch element T7, and another end thereof is connected to the common voltage VCOM. One connection end of the first switch element T1′ is electrically connected to the data line DL, another connection end thereof is electrically connected to the memory element 201, and a control end thereof is connected to the first scan line MM_GL, so that the first scan line MM_GL is used to control the first switch element T1′ to be turned on or off. The sixth switch element T6 is electrically connected between the node ND1 and the capacitor 203, or is electrically connected between the node ND1 and the seventh switch element T7, and the sixth switch element T6 may be controlled by the control signal MM to be turned on or off. The two connection ends of the seventh switch element T7 are respectively electrically connected to the data line DL and one end of the capacitor 203, or are respectively electrically connected to the data line DL and the sixth switch element T6, and the control end of the seventh switch element T7 is electrically connected to the second scan line NM_GL, so that the seventh switch element T7 is controlled to be on or off by the second scan line NM_GL.

With the pixel circuit 20 described in FIG. 4A and FIG. 4B, the electronic device may be switched to a normal display mode or a MIP display mode. Please refer to FIG. 4C and FIG. 4D, wherein FIG. 4C shows the driving timing of the pixel circuit of FIG. 4A in the MIP display mode, and FIG. 4D shows the driving timing of the pixel circuit of FIG. 4A in the normal display mode. As shown in FIG. 4C, in the MIP display mode, the control signal MM is a first voltage level VH (for example, but not limited to, a high voltage level) and the second scan line NM_GL is a second voltage level VL (for example, but not limited to, a low voltage level), so that the sixth switch element T6 is turned on and the seventh switch element T7 is turned off, thereby transmitting data to the memory element 201 for being further written into the capacitor 203. Therefore, the pixel circuit 20 is driven in the MIP display mode, and its detailed driving timing is shown in FIG. 4C. In the normal display mode, please refer to the driving timing of the pixel circuit shown in FIG. 4D in the normal display mode, the control signal MM is the second voltage level VL and the second scan line NM_GL is the first voltage VH, so that the sixth switch element T6 is turned off and the seventh switch element T7 is turned on, whereby, when driving the pixel circuit 20, data may be transmitted to one end of the capacitor 203 for being further written into the capacitor 203. Therefore, the pixel circuit 20 is driven in the normal display mode, and its detailed driving timing is shown in FIG. 4D.

As a result, the electronic device of the present disclosure is provided with a MIP circuit combined with a normal driving circuit in the pixel circuit to achieve the effect of switching between normal display and MIP display by switching the switch elements, thereby reducing the problem of the display panel that is limited by the MIP circuit and cannot perform multi-gray-scale display.

In one embodiment, in the present disclosure, by at least comparing a product through mechanism observation, such as the presence or absence of components or the connection relationship between components, as an evidence, it is able to determine whether the product falls within the patent protection scope of the present disclosure, but it is not limited thereto.

The features of the various embodiments of the present disclosure may be mixed and matched arbitrarily as long as they do not violate the spirit of the invention or conflict with each other.

The aforementioned specific embodiments should be construed as merely illustrative, and not limiting the rest of the present disclosure in any way.

1. An electronic device, comprising:
a substrate;
at least a data line disposed on the substrate for transmitting data; and
at least a pixel circuit disposed on the substrate, including:
a memory element;
a capacitor electrically connected to the memory element;
a first switch element, wherein a connection end of the first switch element is electrically connected to the data line;
a second switch element electrically connected between the first switch element and the memory element; and
a third switch element electrically connected between the first switch element and the capacitor,
wherein the data is transmitted to the memory element when the second switch element is turned on, and the data is transmitted to one end of the capacitor when the third switch element is turned on.

2. The electronic device as claimed in claim 1, further comprising at least a scan line disposed on the substrate and intersected with the data line.

3. The electronic device as claimed in claim 2, wherein a control end of the first switch element is electrically connected to the scan line.

4. The electronic device as claimed in claim 1, wherein the memory element includes a fourth switch element and a fifth switch element that are connected to a node, the fourth switch element is connected between a first signal and the node, and the fifth switch element is connected between a second signal and the node.

5. The electronic device as claimed in claim 4, wherein the memory element turns on the fourth switch element and turns off the fifth switch element to transmit the first signal to the node.

6. The electronic device as claimed in claim 4, wherein the memory element turns on the fifth switch element and turns off the fourth switch element to transmit the second signal to the node.

7. The electronic device as claimed in claim 4, further comprising a sixth switch element electrically connected between the node and the capacitor.

8. The electronic device as claimed in claim 7, further comprising a seventh switch element electrically connected between the data line and the capacitor and electrically connected between the data line and the sixth switch element.

9. The electronic device as claimed in claim 7, wherein the sixth switch element is electrically connected between the node and the third switch element.

10. The electronic device as claimed in claim 1, wherein the memory element includes a first inverter and a second inverter, an output end of the first inverter is connected to an input end of the second inverter, and an output end of the second inverter is connected to an input end of the first inverter.

11. The electronic device as claimed in claim 10, wherein, when the third switch element is turned on to transmit the data to one end of the capacitor, the first inverter and the second inverter are disabled.

12. The electronic device as claimed in claim 1, wherein, when the third switch element is turned on to transmit the data to one end of the capacitor, the second switch element is turned off.

13. The electronic device as claimed in claim 1, wherein, when the second switch element is turned on to transmit the data to the memory element, the third switch element is turned off.

14. The electronic device as claimed in claim 4, wherein the memory element further includes a first inverter and a second inverter, a control end of the fourth switch element is connected to an output end of the second inverter and an input end of the first inverter, and a control end of the fifth switch element is connected to an output end of the first inverter and an input end of the second inverter.

15. The electronic device as claimed in claim 3, wherein another connection end of the first switch element T1 is electrically connected to the memory element.

16. The electronic device as claimed in claim 4, wherein the first signal is a white signal, and the second signal is a black signal.

17. An electronic device, comprising:
a substrate;
at least a data line disposed on the substrate for transmitting data; and
at least a pixel circuit disposed on the substrate, including:
a memory element;
a first switch element, wherein a connection end of the first switch element is electrically connected to the data line;
a sixth switch element, wherein the sixth switch element and the memory element are connected to a node;
a capacitor having a first end electrically connected to the sixth switch element, and a second end electrically connected to a common voltage; and
a seventh switch element electrically connected between the data line and the sixth switch element,
wherein the data is transmitted to the memory element when the sixth switch element is turned on, and the data is transmitted to the first end of the capacitor when the seventh switch element is turned on.

18. The electronic device as claimed in claim 17, wherein another connection end of the first switch element is electrically connected to the memory element, and a control end of the first switch element is connected to a first scan line.

19. The electronic device as claimed in claim 17, wherein the sixth switch element is electrically connected between the node and the seventh switch element.

20. The electronic device as claimed in claim 17, wherein the seventh switch element is electrically connected between the data line and the first end of the capacitor, and a control end of the seventh switch element is electrically connected to a second scan line.
